(19) United States
(12) Patent Application Publication
(10) Pub. No.: US 2017/0067628 A1
(43) Pub. Date: Mar. 9, 2017

(54) Lighting System and Method

(71) Applicant: Hatteras Hammocks, Inc., Greennville, NC (US)

(72) Inventor: Jesse A. Branch, Winterville, NC (US)

(73) Assignee: Hatteras Hammocks, Inc., Greenville, NC (US)

(21) Appl. No.: 15/257,250

(22) Filed: Sep. 6, 2016

Related U.S. Application Data
(60) Provisional application No. 62/215,414, filed on Sep. 8, 2015.

(51) Int. Cl. F21V 33/00; F21S 9/02; F21V 23/04; F21S 4/28

(52) U.S. Cl. CPC F21V 33/0012; F21S 4/28; F21S 9/02; F21V 23/04; F21V 23/0471; F21W 2131/10

(57) ABSTRACT

A lighting system for mounting to the underside of a part of a piece of furniture, such as a chair arm. The lighting system may include; a light strip; and a power source electrically connected to the light strip, wherein the light strip and power source may be configured to be mounted to an underside of the part of the piece of furniture, such that light from the light strip is emitted in a generally downward direction relative to the piece of furniture.

### 1 RELATED APPLICATIONS

This application is related to and claims priority to U.S. Provisional Patent Application No. 62/215,414, filed on Sep. 8, 2015, entitled “Under Arm Furniture Light-Emitting Diode (LED) Lighting System and Method”, the entire disclosure of which is incorporated herein by reference.

### 2 FIELD OF THE INVENTION

This invention pertains generally to a lighting system and more particularly to a lighting system for mounting on the underside of a part of a piece of furniture, such as a chair arm.

### 3 BACKGROUND OF THE INVENTION

People often enjoy sitting in outdoor environments in daytime or nighttime. However, in limited lighting at night, maneuvering in an open outdoor space can be hazardous. Further, outdoor lighting can significantly add to the aesthetics and ambiance of an outdoor area at night. Therefore, it may be beneficial for aesthetic and safety reasons to develop easy and inexpensive lighting solutions for outdoor and/or indoor use.

There is a need for an inexpensive lighting solution for outdoor and/or indoor use capable of being mounted to or incorporated with the underside of a chair arm.

### 4 BRIEF DESCRIPTION OF THE INVENTION

In one embodiment, the invention provides a lighting system. The lighting system may include a light strip; and a power source electrically connected to the light strip, wherein the light strip and power source may be configured to be mounted to an underside of a part of a piece of furniture, such that light from the light strip is emitted in a generally downward direction. The light strip may include one or more light-emitting diodes (LED). The lighting system may further include a housing, wherein the light strip and power source may be housed therein. The part of the piece of furniture may be an underside of a chair arm. The power source may include a battery pack, the battery pack may include one or more batteries. The lighting system may further include a control switch configured for controlling the operation of the light strip. The control switch may include one or more of a manual switch and/or a sensor. The sensor may include one or more of an optical sensor and/or proximity sensor. The housing, with the light strip and power source housed therein, may be configured to be mounted directly to an outer surface of the underside of the part of the piece of furniture. The housing, with the light strip and power source housed therein, may be configured to be mounted within a cavity formed in the underside of the part of the piece of furniture. The light strip and power source may be configured to be mounted within a cavity formed in the underside of the part of the piece of furniture. The light strip and power source may be mounted to the underside of the part of the piece of furniture by one or more of screws, adhesive, hook and loop system, and/or interference fit. The housing, with the light strip and power source housed therein, may be mounted to the underside of the part of the piece of furniture by one or more of screws, adhesive, hook and loop system, and/or interference fit. The power source may include a battery pack and may have a width greater than that of the housing, such that when the battery pack is housed in the housing a portion of the battery pack extends beyond that of a surface of the housing. The portion of the battery pack that extends beyond that of the surface of the housing may include a removable cover. The light strip and power source may be mounted to the underside of the chair arm such that the light strip is proximate an inner edge of the chair arm. The housing, with the light strip and power source housed therein, may be mounted to the underside of the chair arm such that the light strip is proximate an inner edge of the chair arm.

In another embodiment, the invention provides a chair including a lighting system. The lighting system may include a light strip; and a power source electrically connected to the light strip, wherein the light strip and power source may be configured to be mounted to an underside of an arm of the chair, such that light from the light strip is emitted in a generally downward direction.

In yet another embodiment, the invention provides a method of installing a lighting system to a piece of furniture. The method may include providing a lighting system. The lighting system may include a light strip; and a power source electrically connected to the light strip, wherein the light strip and power source may be configured to be mounted to an underside surface of a part of the piece of furniture, such that light from the light strip is emitted in a generally downward direction. The method may further include securing the lighting system to the underside surface of the part of the piece of furniture.

In still yet another embodiment, the invention provides a method of installing a lighting system to a piece of furniture. The method may include providing a lighting system. The lighting system may include a light strip; and a power source electrically connected to the light strip, wherein the light strip and power source may be configured to be mounted to an underside surface of a part of the piece of furniture, such that light from the light strip is emitted in a generally downward direction. The method may further include forming a cavity in the piece of furniture, wherein the cavity is formed with dimensions that substantially correspond to the footprint and depth of the lighting system; and securing the lighting system within the cavity.

These and other embodiments will be apparent from the ensuing specification.

### 5 BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates an example of the presently disclosed lighting system.

FIG. 2 illustrates an example of a schematic diagram of the presently disclosed lighting system.

FIG. 3 illustrates a perspective view of the presently disclosed lighting system mounted on the undersides of the arms of a chair.

FIG. 4 illustrates an example of the underside of a chair arm showing the presently disclosed lighting system in relation thereto.

FIG. 5A illustrates the underside of the chair arm shown in FIG. 3, wherein the underside of the chair arm includes a groove or cavity for receiving the presently disclosed lighting system.

FIG. 5B illustrates the underside of the chair arm shown in FIG. 3, wherein the underside of the chair arm includes an alternate embodiment of a groove or cavity for receiving components of the presently disclosed lighting system.

FIG. 6 illustrates another example of a chair in which a pair of lighting systems is mounted on the undersides of the arms.

FIG. 7 illustrates a flow diagram of an example of a method of installing the presently disclosed LED lighting system in the underside of a chair arm.

FIG. 8 illustrates a flow diagram of an example of a method of installing components of the presently disclosed LED lighting system in the underside of a chair arm.

### 6 DETAILED DESCRIPTION OF THE INVENTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof.

In some embodiments, the presently disclosed subject matter provides a lighting system, such as a light-emitting diode (LED) lighting system, for mounting on the underside of a piece of furniture, such as a chair arm. The lighting system may include a light strip, such as a LED light strip, that is electrically coupled to a power source, such as a battery pack, or alternatively an AC source, such as 110 volt AC. The lighting system may further include a housing for housing the light strip and power source. In one example, the lighting system may be attached directly to an underside surface of a chair arm. In another example, the lighting system may be fitted into a groove or cavity formed in the underside of a chair arm. The presently disclosed subject matter also provides a light-enabled chair in which a lighting system is installed in the underside of at least one arm, but preferably both arms. The light-enabled chair can be a chair intended for outdoor use, indoor use, or both outdoor and indoor use. While any suitable light emitting source may be used as the light source for the lighting system, the remainder of the description herein will described the invention in the context of a light-emitting diode (LED) as the light source. However, it is contemplated that any suitable light emitting source may be used.

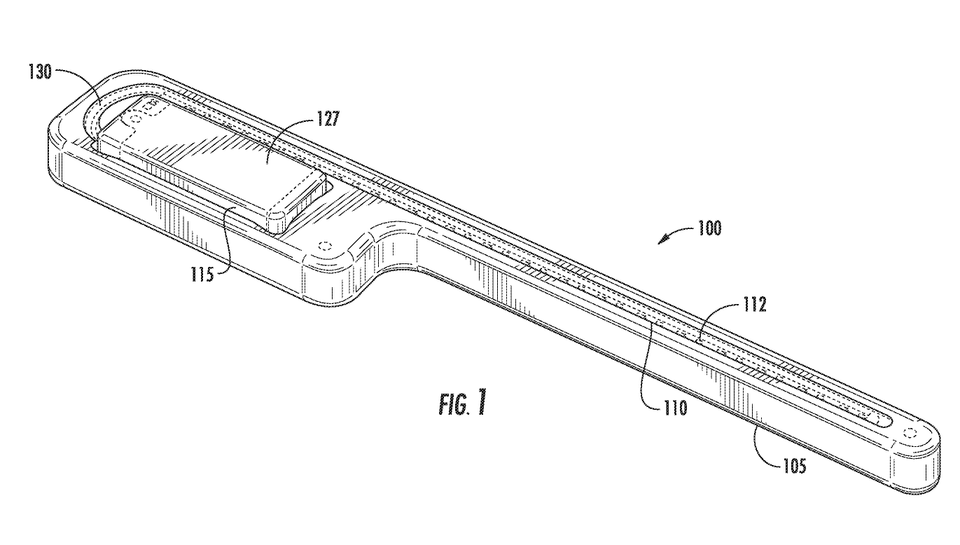

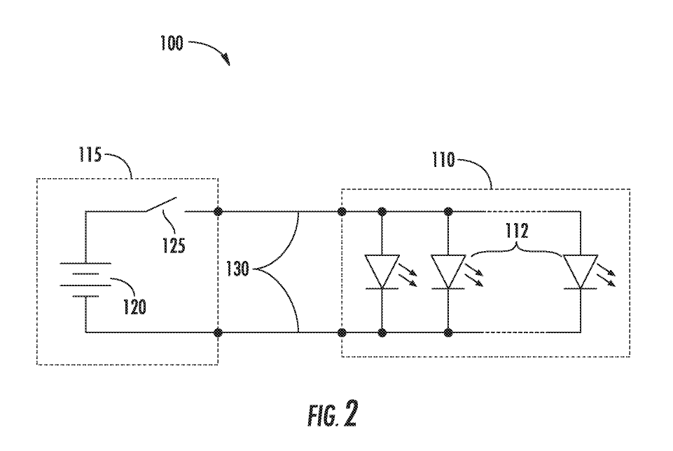

Referring now to FIG. 1 is a plan view of an example of the presently disclosed LED lighting system 100 for mounting on the underside of a chair arm. The LED lighting system 100 preferably includes a housing 105, an LED strip 110, and a power source 115. The LED strip 110 and the power source 115 may be electrically connected via a cable 130. In one example, the cable 130 includes wires or leads electrically connecting the power source 115 to LED strip 110. The LED strip, power source 115, and cable 130 are preferably housed within housing 105. Housing 105 may be made of a plastic composite material, such as DuraWood®, or any other suitable material. FIG. 2 shows an exemplary schematic diagram of LED lighting system 100. Referring now to FIG. 2, the LED strip 110 can include any number and arrangement of LEDs 112. The LEDs 112 can be any color, all the same color, or any combinations of different colors. In one example, the LED strip 110 may be about 12 inches long with multiple white LEDs.

The power source 115 can be, for example, a battery pack that includes one or more batteries 120 and a control switch 125, wherein the control switch 125 may function as an ON/OFF switch. Control switch 125, may further include and control other functions, such as light intensity (dimmer), light color, and/or the like. The battery pack can be, for example, a plastic housing with a removable cover 127, wherein the control switch 125 may be mounted on the plastic housing. The control switch 125 may be a manual switch or a sensor (e.g., optical sensor, proximity sensor, and/or the like) for controlling the LED strip 110. The one or more batteries 120 may be, for example, two standard AA batteries, two standard AAA batteries, or other suitable battery or combination of batteries. The one or more batteries 120 may be rechargeable or non-rechargeable. The size of the battery pack and the type of batteries can vary depending on, for example, the size of the chair arm in which it is installed. In another example, the power source 115 may be an AC adaptor that may be plugged into a standard 110 V AC outlet. In yet another example, the power source 115 may include a solar cell or panel for providing power and/or charging batteries 120.

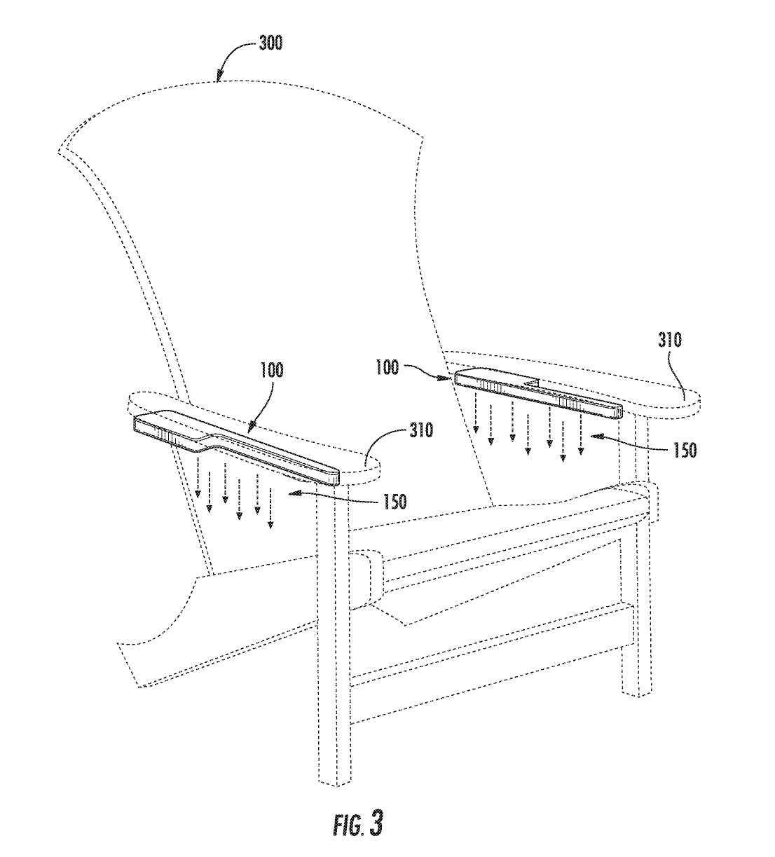

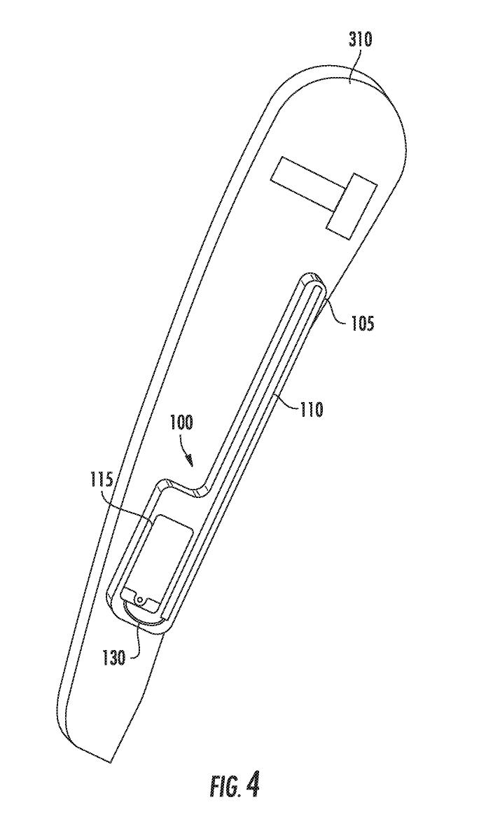

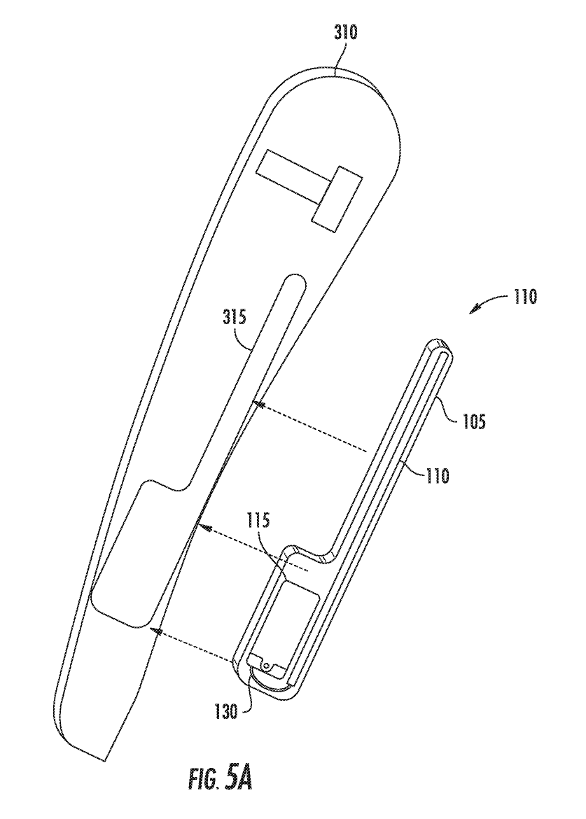

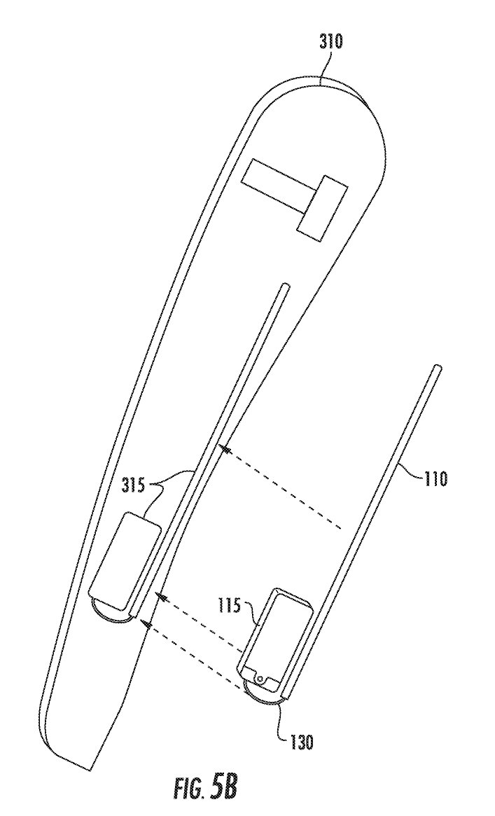

Referring now to FIG. 3 is a perspective view of an example of a chair 300 in which a pair of LED lighting systems 100 is mounted on the undersides of the arms. In this example, the chair 300 is a wooden or plastic “Adirondack” style of chair. Accordingly, the chair 300 is an example of a light-enabled chair that is intended for outdoor use. A first LED lighting system 100 is mounted on the underside of one arm 310. A second LED lighting system 100 is mounted on the underside of the other arm 310. In one example, LED lighting system 100 is installed such that the long side of LED lighting system 100 (LED strip 110 portion) is positioned closest to the inside of each of the arms 310. FIG. 3 shows light 150 emitting from each of the mounted LED lighting systems 100 in a generally downward direction from the underside of the arm 310. More details of the LED lighting system 100 with respect to the arm 310 are shown in FIG. 4 and FIG. 5.

Referring now to FIG. 4 is a plan view of the LED lighting system 100 in relation to the underside of the chair arm 310 of chair 300. In this example, the LED lighting system 100 is installed directly to the underside surface of the arm 310. In one example, the LED lighting system 100 may be secured to the underside surface of the arm 310 using any suitable fastener, such as one or more of screws, adhesive, hook and loop system, interference fit, and/or the like, or any combination of the above.

In another embodiment, for example as shown in FIG. 5A, the LED lighting system 100 may be installed within a cavity 315 formed in the underside of arm 310, wherein the cavity 315 is formed with dimensions designed to receive the LED lighting system 100. The footprint and depth of the cavity 315 substantially corresponds to the footprint and depth of the LED lighting system 100. In one example, the cavity 315 may be of a depth such that when the LED lighting system 100 is installed within cavity 315 the power source 115 may sit slightly proud relative to the underside surface of arm 310, so that the cover (e.g., removable cover 127) of power source 115 is accessible to allow for easy access for the installation/removal of batteries. In one example, the LED lighting system 100 may be fastened within the cavity 315, and thus to the arm 310, using any suitable fastener, such as one or more of screws, adhesive, hook and loop system, interference fit, and/or the like, or any combination of the above. In one example, cavity 315 is formed such that the long side of LED lighting system 100 (LED strip 110 portion) when installed is positioned closest to the inside of the arm 310. Cavity 315 may be formed in the underside of arm 310 by any suitable technique, such as milling, routing, molding, or the like.

In another embodiment, for example as shown in FIG. 5B, the individual components LED strip 110, power source 115, and cable 130 of the LED lighting system 100 (absent housing 105), may be directly installed within a cavity 315 formed into the underside of the arm 310, wherein the cavity 315 is formed with dimensions designed to receive the individual components of the LED lighting system 100. The footprint and depth of the cavity 315 substantially corresponds to the footprint and depth of the individual components of the LED lighting system 100. In one example, the portion of the cavity 315 that houses LED strip 110 may run along the inner edge of the arm 310, and may preferably be about equidistant from front to back and may be slightly offset from the inner edge of the arm 310 to maximize the throw of the light while still being hidden. The portion of the cavity 315 that houses power source 115 may be of a depth such that the power source 115 may sit slightly proud relative to the underside surface of arm 310, so that the cover of power source 115 is accessible to allow for easy access for the installation/removal of batteries. Further, the portion of the cavity 315 that houses power source 115 may be formed as a pocket with bubble radius corners for ease of removal/installation. The individual components of the LED lighting system 100 may be fastened within the cavity 315, and thus to the arm 310, using any suitable fastener, such as one or more of screws, adhesive, hook and loop system, interference fit, and/or the like, or any combination of the above. Cavity 315 may be formed in the underside of arm 310 by any suitable technique, such as milling, routing, molding, or the like.

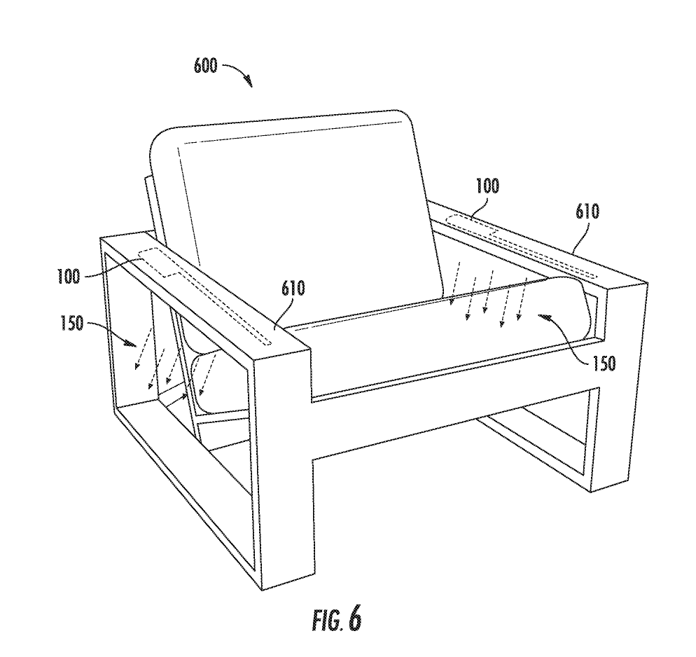

Referring now to FIG. 6 is a perspective view of another example of a chair 600 in which a pair of LED lighting systems 100 is mounted on the undersides of the arms 610. The chair 600 is an example of a light-enabled chair that is intended for indoor use.

Referring now again to FIG. 1 through FIG. 6, the size, shape, and configuration of the LED strip 110, the power source 115, and the cable 130 of the LED lighting system 100 is not limited to that which is shown and described with reference to FIG. 1 through FIG. 6. Nor is the position of the LED lighting system 100 on the underside of the chair arm limited to that shown in FIG. 3 through FIG. 6. The specific sizes, shapes, and configurations of the housing 105, LED strip 110, power source 115, and cable 130 of the LED lighting system 100 and placement under the chair arm can vary depending on the features of the chair, as well as the mounting dimensions.

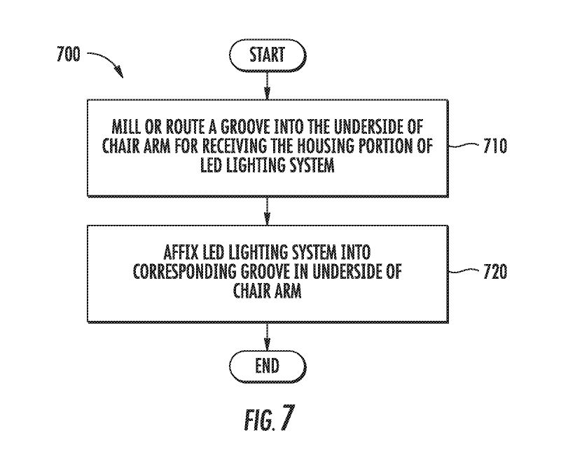

Referring now to FIG. 7 is a flow diagram of an example of a method 700 of installing the presently disclosed LED lighting system 100 in the underside of a part or a piece of furniture, e.g., a chair arm. The method 700 may include, but is not limited to, the following steps.

At a step 710, a groove for receiving the LED lighting system 100 is milled or routed into the underside of the part of the piece of furniture, e.g., chair arm. For example, and referring to the cavity 315 shown in FIG. 5A, the groove is formed with dimensions to substantially correspond to the footprint and depth of the housing 105 of LED lighting system 100. The groove preferably is formed such that when mounted therein the LED strip 110-portion is closest to the inner edge of the chair arm.

At a step 720, the LED lighting system 100 is installed (affixed) into the groove that has been milled or routed into the underside of the chair arm. For example, the LED lighting system 100 is fitted into the groove and held therein using any suitable fastener, such as one or more of screws, adhesive, hook and loop system, interference fit, and/or the like, or any combination of the above.

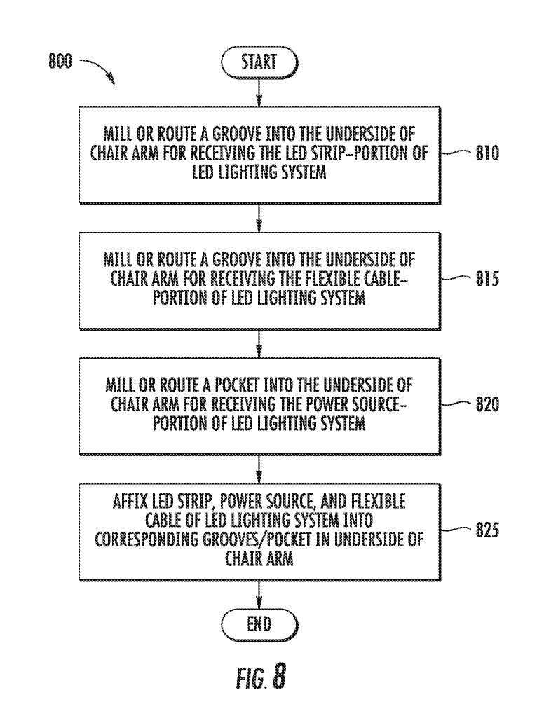

Referring now to FIG. 8 is a flow diagram of an example of a method 800 of installing the individual components LED strip 110, power source 115, and cable 130 of the LED lighting system 100 (absent housing 105) of the presently disclosed LED lighting system 100 in the underside of a part of a piece of furniture, e.g., chair arm. The method 800 may include, but is not limited to, the following steps.

At a step 810, the groove for receiving the LED strip 110-portion of the LED lighting system 100 is milled or routed into the underside of the part of the piece of furniture, e.g., a chair arm. For example and referring to the cavity 315 shown in FIG. 5B, this groove is formed with dimensions to substantially correspond to the footprint and depth of the LED strip 110-portion. The groove preferably runs along and is slightly inset from the inner edge of the chair arm.

At a step 815, the groove for receiving the flexible cable 130-portion of the LED lighting system 100 is milled or routed into the underside of the chair arm. For example and referring to the cavity 315 shown in FIG. 5B, this groove is formed with dimensions to substantially correspond to the footprint and depth of the flexible cable 130 and follows its line.

At a step 820, the pocket for receiving the power source 115-portion of the LED lighting system 100 is milled or routed into the underside of the chair arm. For example and referring to the cavity 315 shown in FIG. 5, this pocket may include bubble radius corners and is formed with dimensions to substantially correspond to the footprint and depth of the power source 115-portion. However, the depth may be such that the power source 115 sits slightly proud relative to the underside surface of the arm 310, so that a cover of power source 115 is accessible to allow for easy access for the installation/removal of batteries.

The steps 810, 815, and 820 may be performed in any order.

At a step 825, the LED strip 110, the power source 115, and the flexible cable 130 of the LED lighting system 100 are installed (affixed) into the grooves/pocket that have been milled or routed into the underside of the chair arm. For example, the flexible cable 130 and the power source 115 are fitted into their corresponding groove and pocket, respectively, and held therein using any suitable fastener, such as one or more of screws, adhesive, hook and loop system, interference fit, and/or the like, or any combination of the above.

Techniques other than that which is described in the methods 700 and 800 can be used for installing the presently disclosed LED lighting system 100 in or on the underside of a chair arm. For example, without milling or routing, the LED lighting system 100 may be simply installed directly to the underside surface of the chair arm using any suitable fastener, such as screws, adhesive, hook and loop system, interference fit, and/or the like, or any combination of the above.

Following long-standing patent law convention, the terms “a,” “an,” and “the” refer to “one or more” when used in this application. Thus, for example, reference to “a subject” includes a plurality of subjects, unless the context clearly is to the contrary (e.g., a plurality of subjects), and so forth.

Throughout this specification, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and figures, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the description herein.

What is claimed is:

1. A lighting system, comprising:
a. a light strip; and
b. a power source electrically connected to the light strip, wherein the light strip and power source are configured to be mounted to an underside of a part of a piece of furniture, such that light from the light strip is emitted in a generally downward direction relative to the piece of furniture.

2. The lighting system of claim 1 wherein the light strip comprises one or more light-emitting diodes (LED).

3. The lighting system of claim 1 further comprising a housing, wherein the light strip and power source are housed therein.

4. The lighting system of claim 1 wherein the part of the piece of furniture comprises an underside of a chair arm.

5. The lighting system of claim 1 wherein the power source comprises a battery pack, the battery pack comprising one or more batteries.

6. The lighting system of claim 1 further comprising a control switch configured for controlling the operation of the light strip.

7. The lighting system of claim 6 wherein the control switch comprises one or more of a manual switch and a sensor.

8. The lighting system of claim 7 wherein the sensor comprises one or more of an optical sensor and proximity sensor.

9. The lighting system of claim 3 wherein the housing, with the light strip and power source housed therein is configured to be mounted directly to an underside surface of the part of the piece of furniture.

10. The lighting system of claim 3 wherein the housing, with the light strip and power source housed therein is configured to be mounted within a cavity formed in the underside of the part of the piece of furniture.

11. The lighting system of claim 1 wherein the light strip and power source are configured to be mounted within a cavity formed in the underside of the part of the piece of furniture.

12. The lighting system of claim 1 wherein the light strip and power source are mounted to the underside of the part of the piece of furniture by one or more of screws, adhesive, hook and loop system, and/or interference fit.

13. The lighting system of claim 3 wherein the housing, with the light strip and power source housed therein is mounted to the underside of the part of the piece of furniture by one or more of screws, adhesive, hook and loop system, and/or interference fit.

14. The lighting system of claim 3 wherein the power source comprises a battery pack and has a thickness greater than that of the housing, such that when the battery pack is housed in the housing a portion of the battery pack extends beyond that of a surface of the housing.

15. The lighting system of claim 14 wherein the portion of the battery pack that extends beyond that of the surface of the housing comprises a removable cover.

16. The lighting system of claim 4 wherein the light strip and power source is mounted to the underside of the chair arm such that the light strip is proximate an inner edge of the chair arm.

17. The lighting system of claim 3 wherein the housing, with the light strip and power source housed therein, is mounted to an underside of a chair arm such that a portion of the housing comprising the light strip is proximate an inner edge of the chair arm.

18. A chair comprising:
a. a lighting system, the lighting system comprising:
i. a light strip; and
ii. a power source electrically connected to the light strip, wherein the light strip and power source are configured to be mounted to an underside of an arm of the chair, such that light from the light strip is emitted in a generally downward direction relative to the underside of the arm of the chair.

19. A method of installing a lighting system to a piece of furniture, comprising:
a. providing a lighting system, the lighting system comprising:
i. a light strip; and
ii. a power source electrically connected to the light strip, wherein the light strip and power source are configured to be mounted to an underside surface of a part of the piece of furniture, such that light from the light strip is emitted in a generally downward direction relative to the piece of furniture;
b. securing the lighting system to the underside surface of the part of the piece of furniture.

20. A method of installing a lighting system to a piece of furniture, comprising:
a. providing a lighting system, the lighting system comprising:
i. a light strip; and
ii. a power source electrically connected to the light strip, wherein the light strip and power source are configured to be mounted to an underside of a part of the piece of furniture, such that light from the light strip is emitted in a generally downward direction relative to the piece of furniture;
b. forming a cavity in the piece of furniture, wherein the cavity is formed with dimensions that substantially correspond to the footprint and depth of the lighting system; and
c. securing the lighting system within the cavity.
